(19) United States
(12) Patent Application Publication
(10) Pub. No.: US 2018/0136366 A1
(43) Pub. Date: May 17, 2018

(54) DISTRIBUTED SOLAR ENERGY PREDICTION IMAGING

(71) Applicant: Board of Regents, The University of Texas System, Austin, TX (US)

(72) Inventors: ROLANDO E. VEGA-AVILA, SAN ANTONIO, TX (US); WALTER B. RICHARDSON, Jr., SAN ANTONIO, TX (US); HARIHARAN KRISHNASWAMI, HELOTES, TX (US); MICHAEL CERVANTES, SAN ANTONIO, TX (US)

(21) Appl. No.: 15/577,441

(22) PCT Filed: May 27, 2016
(86) PCT No.: PCT/US2016/034657

§ 371 Date: Nov. 28, 2017

Related U.S. Application Data
(60) Provisional application No. 62/168,403, filed on May 29, 2015.

(51) Int. Cl. G01W 1/10; G06N 7/00; G06T 11/60; G06T 7/11

(52) U.S. Cl. CPC G01W 1/10; G06N 7/005; G06T 2207/30192; G06T 7/11; G06T 11/60

(57) ABSTRACT

Concepts of distributed solar energy prediction imaging are described. In one embodiment, a solar forecast system includes a computing environment, a network, and an imaging device. Among other elements, the imaging device can include a wide-angle optical component, an imaging assembly, and a computing device. The computing device of the imaging device can capture an array of images using the imaging assembly, combine the array of images into a combined-resolution image, transform the combined-resolution image into a transformed image based on a calibration transformation matrix associated with the wide-angle optical component, identify and track cloud features in the transformed image, and generate a solar forecast using ray tracing based on the cloud features. The imaging device can also transmit the solar forecast to the computing environment via the network, and the computing environment can fuse solar forecast data from several imaging device into a distributed geographic area forecast.

### CROSS REFERENCE TO RELATED APPLICATIONS

This application claims the benefit of U.S. Provisional Application No. 62/168,403, filed May 29, 2015, the entire contents of which is hereby incorporated herein by reference.

### BACKGROUND

The United States Department of Energy (DOE) estimates that solar-generated power will grow to satisfy a larger percentage of the electricity supply by 2030. This trend will only continue as the price of solar electricity reaches a point at which it is cost-competitive with other forms of electricity sources. At the same time, it is important that the stability and reliability of the power grid be maintained under the high penetration of variable resources such as solar-generated power. The difference between the actual load and the power generated by solar-generated power systems can be termed net load. Managing this net load under the relative variability and uncertainty associated with solar electricity is a challenge faced by grid operators.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a networked computing environment for distributed solar energy prediction according to various embodiments described herein.

FIG. 2 illustrates an example process of solar energy prediction imaging performed by an imaging device shown in FIG. 1 according to various embodiments described herein.

FIG. 3 illustrates an example array of images captured by the imaging device shown in FIG. 1 according to various embodiments described herein.

FIG. 4 illustrates an example calibration table setup and geometric transformation matrix for distortion self-calibration according to various embodiments described herein.

FIG. 5 illustrates an example result of a cloud matching and tracking process according to various embodiments described herein.

FIG. 6 illustrates an example process for distributed solar energy prediction imaging performed by a computing environment shown in FIG. 1 according to various embodiments described herein.

### DETAILED DESCRIPTION

As noted above, net load can be defined as the difference between the actual load and the power generated by solar-generated power systems. Managing net load under the relative variability and uncertainty associated with solar electricity is a challenge faced by grid operators. In that context, an accurate forecasting model in the intra-hour time scale could be an effective tool to reduce the uncertainty involved in managing net load in real-time or near real-time scenarios.

In the context of reducing the uncertainty involved in managing net load, solar forecasting may be a key factor for efficiently and reliably integrating solar power. The majority of research in solar forecasting has been in the day-ahead timeframes that correspond to single-value regional assessments over wide regional areas which do not necessarily improve the capability of persistence models when run over shorter timeframes. However, solar irradiance is not constant over such regional geographic regions. Solar irradiance behaves as a stochastic process over time and space, warranting a more comprehensive examination.

Today, one problem for accurate solar forecasting, whether physics-based or data-analytics based, is the lack of reliable rich sky data that can be utilized to better identify mass transfer and thermal properties of air and water particles in the sky. From far away, satellite technology and remote sensing has exploited and made use of the vast amount of data at the mesoscale level. However, satellite data is insufficient to provide the needed pixel, spatial, temporal, and radiometric resolution for evaluating the radiative transfer within the atmosphere, especially for interacting with clouds at high scattering angles and accurately depicting the circumsolar region.

Examples of factors which current solar forecasting methods do not address include: (1) visibility range limitations due to the curvature of the earth, (2) cloud discontinuity away from the cardinal zenith resulting in vertical cloud layer depths that are projected to a horizontal plane, (3) the impractically-high cost of existing technologies, and (4) lack of scalability and accessibility for hundreds or thousands of users.

In the context outlined above, systems and methods of distributed solar energy prediction imaging are described herein. In various aspects of the embodiments, one or more relatively low-cost distributed multi-modal sky-imaging devices, forecasting and fusion models, and publish/subscribe telemetry communication protocols are described. The systems and methods can be embodied in hardware, software, or a combination of hardware and software in various distributed arrangements.

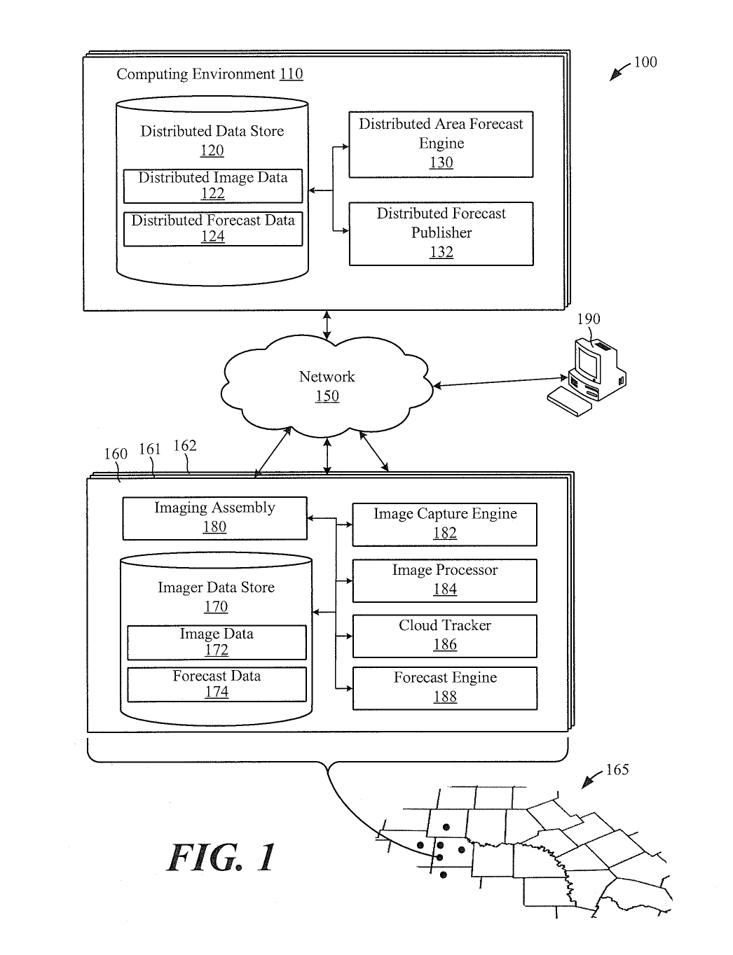

Turning to the figures, a networked computing environment for distributed solar energy prediction is described followed by a description of the operation of the same. FIG. 1 illustrates a networked computing environment 100 for distributed solar energy prediction. The networked environment 100 includes a computing environment 110, a network 150, geographically dispersed imaging devices 160-162, and a client device 190. The computing environment 110 includes a distributed data store 120, a distributed area forecast engine 130, and a distributed forecast publisher 132. The types of data stored in the distributed data store 120 and the functions of the distributed area forecast engine 130 and the distributed forecast publisher 132 are described in further detail below.

The computing environment 110 can be embodied as one or more computers, computing devices, or computing systems. In certain embodiments, the computing environment 110 can include one or more computing devices arranged, for example, in one or more server or computer banks. The computing device or devices can be located at a single installation site or distributed among different geographical locations. The computing environment 110 can include a plurality of computing devices that together embody a hosted computing resource, a grid computing resource, and/or other distributed computing arrangement. In some cases, the computing environment 110 can be embodied as an elastic computing resource where an allotted capacity of processing, network, storage, or other computing-related resources varies over time. The computing environment 110 can also be embodied, in part, as various functional and/or logic elements configured to direct the computing environment 110 to perform aspects of the embodiments described herein.

The network 150 can include the Internet, intranets, extranets, wide area networks (WANs), local area networks (LANs), wired networks, wireless networks, cable networks, satellite networks, other suitable networks, or any combinations thereof. It is noted that the computing environment 110 can communicate with the imaging devices 160-162 and the client device 190 using any suitable systems interconnect protocols such as hypertext transfer protocol (HTTP), message queuing telemetry transport (MQTT) protocol, simple object access protocol (SOAP), representational state transfer (REST), real-time transport protocol (RTP), user datagram protocol (UDP), interne protocol (IP), transmission control protocol (TCP), file transfer protocol (FTP), and/or other protocols for communicating data over the network 150, without limitation. It is noted here that, although not illustrated, the network 150 can include connections to any number of client devices or network hosts, such as website servers, file servers, networked computing resources, databases, data stores, or any other network devices or computing systems.

The imaging devices 160-162 are representative of various type(s) of imaging devices capable of sky-directed partial- or all-sky field of view image capture. As shown in FIG. 1, the imaging devices 160-162 can be geographically distributed over the region 165, for example, among other regions. In various embodiments, the networked computing environment 100 can include any number of imaging devices similar to the imaging devices 160-162. The imaging devices 160-162, among others, can be distributed in any way over the region 165 (and other regions).

In underlying processing hardware, the imaging device 160 can be embodied as analog, digital, or mixed analog and digital processing circuitry, including memory. The imaging device 160 can be embodied as a collection of embedded- or application-specific logic, software, and/or hardware capable of capturing and processing images and image-related data as described herein. In that context, the imaging device 160 can include, at least in part, computer instructions that, when executed by processing circuitry of the imaging device 160, direct the imaging device 160 to perform various image processing tasks.

As shown in FIG. 1, the imaging device 160 includes an imager data store 170, an imaging assembly 180, an image capture engine 182, an image processor 184, a cloud tracker 186, and a forecast engine 188. The imager data store 170 includes memory areas for the image data 172 and the forecast data 174. The image data 172 includes the data for images captured by the imaging assembly 180, as well as data for images (and combinations of images) processed by the image processor 184. The forecast data 174 includes, in one embodiment, forecasting model data suitable to provide solar energy forecasts. The forecasting model data can include expected solar energy levels associated with various geographic regions, over time, at a relatively granular intra-hour (or faster) time scale.

The imaging assembly 180 can be embodied as any suitable imaging assembly capable of sky-directed partial- or all-sky field of view image capture. As an example of the imaging assembly 180 (or parts of the imaging assembly 180), it can be embodied as the Total Sky Imager model 880 (TSI-880) or model 440 (TSI-440) devices (collectively, “TSI devices”) manufactured by Yankee Environmental Systems, Inc. of Turners Falls, Mass. TSI devices take a relatively low resolution color image of the sky using a charge-couple-device (CCD) sensor suspended above a convex dome mirror with a sun-blocking band and camera arm. The sun-blocking band and camera arm occlude about 8% of the sky. The TSI devices have a down-pointing camera with a relatively low image resolution, low sensitivity, and low full well depth capacity that limits the accuracy to capture cloud advection properties in proximity to the sun's disk and near the horizon. Without the sun blocking band, the TSI devices were not designed to prevent internal camera reflections, blooming, and potential sensor damage. Thus, the sun-blocking band and camera sensing capabilities represent a limitations of TSI devices for solar energy forecasting.

As another example of the imaging assembly 180, the U.S Geological Survey (USGS) developed the High Dynamic Range All-Sky Imaging System (HDR-ASIS) for climate research pertaining to atmosphere-radiation-photosynthesis relations, ecosystem carbon dynamics, and image-based monitoring of aerosols. The HDR-ASIS consists of an upward-pointing color camera with a complementary-metal-oxide-semiconductor (CMOS) sensor coupled a fisheye lens to capture instantaneous 2π steradian photos of the sky. A drawback of fisheye lenses is the angular distortion of captured image when a hemispherical lens is translated into a finite two-dimensional area. For this reason, commonly, one of two (e.g., equidistant and equisolid) angle distortion models for fisheye lenses can be adopted and stored in the imager data store 170. But, despite the sky distortion, the HDR-ASIS camera uses a CMOS sensor to reduce the blooming effect of CCD sensors.

Other ground-based systems used to measure solar radiation for sky imaging include that of University of Granada in Spain, which has been calibrated to measure sky irradiance. The University of California at San Diego has a system similar to the HDR-ASIS devised specifically for solar energy forecasting, but using a CCD camera sensor. The use of other imaging systems to capture photographs or images of the sky are within the scope of the embodiments.

The image capture engine 182 is configured to control the imaging assembly 180 to capture images of the sky over time. As described in further detail below, the image capture engine 182 can direct the imaging assembly 180 to capture a sequence of image captures over time using varied parameters. In that way, the image capture engine 182 can direct the imaging assembly 180 to capture an array of images each having a different level of exposure or saturation, for example. An array of images can include any number of images, such as between three and fifteen images, for example, although other numbers of images are within the scope of the embodiments. The image capture engine 182 can direct the imaging assembly 180 to capture arrays of images at periodic intervals, such as every ten, twenty, or thirty seconds, for example, among other periods of time. The images captured by the imaging assembly 180 can be stored as part of the image data 172 in the imager data store 170.

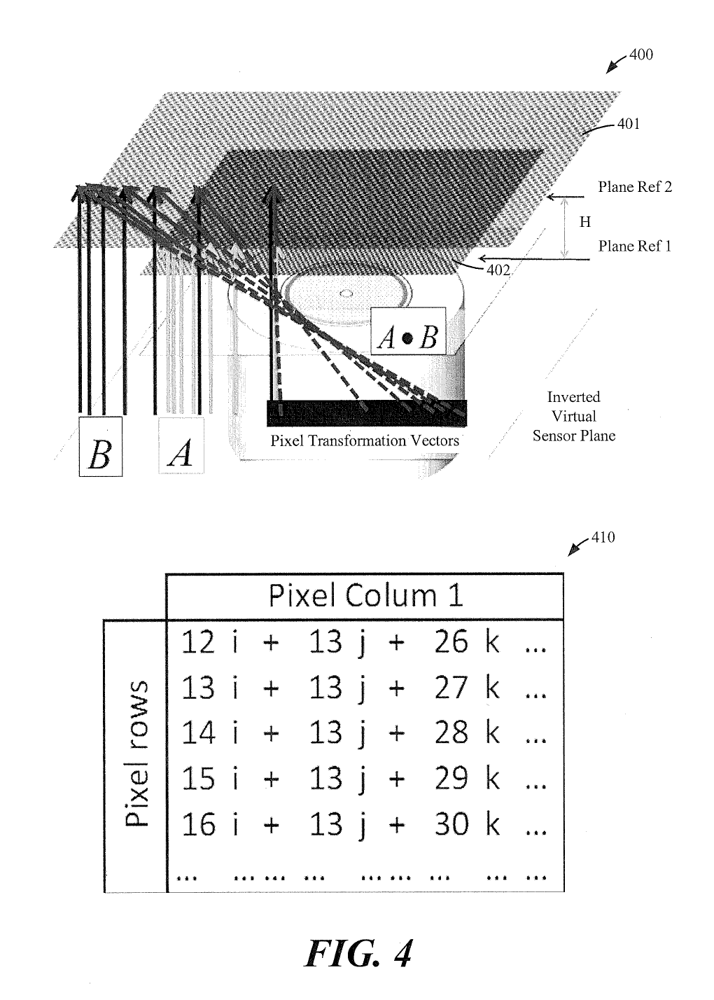

The image processor 184 is configured to combine one or more arrays of images captured by the imaging assembly 180 into a combined-detail image. In that context, the image processor 184 can perform tone mapping, high dynamic range processing, image spatial transformation processing, image data fusion, and other image processing techniques on one or more images as described in further detail below. Generally, tone mapping is a technique to map one set of colors or other data to another to approximate the appearance of high dynamic range images. An image spatial transformation redefines geometric relationships between points between input and output images. According to the embodiments described herein, such a transformation can be achieved using a calibration transformation matrix. The calibration transformation matrix can be predefined through manufacturing specifications of lenses, for example, and/or determined empirically through self-calibration as described below with reference to FIG. 4.

The cloud tracker 186 is configured to perform cloud feature identification, matching, and tracking processes based on the combined-detail images. In that context, the cloud tracker 186 can identify and track clouds in images over time. During the tracking process, the cloud tracker 186 records the direction, speed, and change in area of individual clouds over time. That data can be stored in the imager data store 170. In the case of multiple clouds, the direction, speed, and change in area can be calculated by the cloud tracker 186 to the weighted centroid of detected cloud regions.

The forecast engine 188 is configured to create (or predict) the future positions of clouds in the sky. Using those predictions, the forecast engine 188 can provide solar forecast data and solar energy forecasts. In the prediction of the future positions of clouds in the sky, the forecast engine 188 can create images of what the sky is expected to look like in the future. To do so, the forecast engine 188 can crop out (e.g., remove) clouds from current sky images (or begin with clear sky images) and reposition those clouds in a new locations based on the direction, speed, and change in area information determined by the cloud tracker 186. The solar forecast data and solar energy forecasts generated by the forecast engine 188 can be stored as part of the forecast data 174.

The forecast data 174 can be transmitted over time to the computing environment 110 via the network 150. Similarly, forecast data generated by the imaging devices 161 and 162 (and other imaging devices) can be transmitted to the computing environment 110. In one embodiment, each of the imaging devices 160-162 conducts image capture, image processing, cloud tracking, and solar forecasting processes and transmits, but transmits a relatively small amount of that data to the computing environment 110. In other cases, each of the imaging devices 160-162 can capture images and transmit those images to the computing environment 110 for processing. In that context, it should be appreciated that one or more of the functions or processes performed by the imaging assembly 180, image capture engine 182, image processor 184, cloud tracker 186, and forecast engine 188 can be performed by the computing environment 110.

Turning back to the computing environment 110, the distributed data store 120 includes memory areas for the distributed image data 122 and the distributed forecast data 124. The distributed image data 122 includes the data for images captured by one or more of the imaging devices 160-162, for example, among other imaging devices. The distributed forecast data 124 includes data prepared by the distributed area forecast engine 130, which is based on the forecast information aggregated from the imaging devices 160-162. In one embodiment, the distributed forecast data 124 includes distributed geographic area solar forecast data related to solar energy forecasts over a relatively large geographic region such as the region 165. The distributed forecast data 124 can include expected solar energy levels associated with the region 165, over time, at a relatively granular intra-hour (or faster) time scale.

The distributed area forecast engine 130 is configured to combine the respective solar forecasts received from each of the imaging devices 160-162 into a distributed geographic area solar forecast. Additionally or alternatively, the distributed area forecast engine 130 can fuse together sky images (e.g., current, past, and/or future sky images) received from the imaging devices 160-162 to generate a distributed geographic area solar forecast as described herein. The distributed forecast publisher 132 is configured to publish or make available the distributed geographic area solar forecast generated by the distributed area forecast engine 130.

The client device 190 is representative of any number of client devices, each of which can be embodied as a processor based device or system, including those embodied in the form of a desktop computer, a laptop computer, a personal digital assistant, a cellular telephone, or a tablet computer, among others. The client device 190 can also include one or more peripheral devices. In this context, the peripheral devices may include one or more input devices, such as a keyboard, keypad, touch pad, touch screen, microphone, camera, etc. In various embodiments, the client device 190 can access solar forecast data stored in or published by the computing environment 110 and/or the imaging devices 160-162.

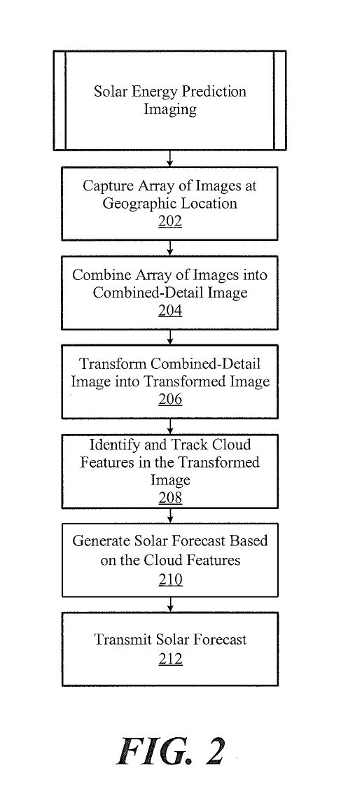

FIG. 2 illustrates an example process of solar energy prediction imaging performed by the imaging device 160 shown in FIG. 1 according to various embodiments described herein. Although the process in FIG. 2 is described in connection with the imaging device 160, any number of other imaging devices, such as one or more of the imaging devices 161 and 162, can perform the process.

At step 202, the process includes the imaging assembly 180 capturing one or more images. For example, the image capture engine 182 can direct the imaging assembly 180 to capture an array of images at various levels of exposure, shutter speed, saturation, etc. As noted above, obtaining an all-sky field of view represents a challenge for digital photography in terms of the relatively large spatial range and dynamic intensity of natural illumination. The dynamic intensity range needed for all-sky imaging is particularly a problem during daylight hours when the intensity gradients between the circumsolar region around the sun and dark cloud bases can be significant, causing a potential saturation of CCD and CMOS sensors. In color graphics, each color can be defined from a palette of 16,777,216 colors (24 bits: 8 red, 8 green, 8 blue), for example, to store raw image information, but the intensity range from only 0 to 255 (8-bit channels have integer values up to 28-1=255) might not be sufficient to characterize the full range of light intensities. As a result, images with fixed exposures may show areas of under- or over-saturated pixels. These regions of over- and under-saturated pixels translate to the loss of information.

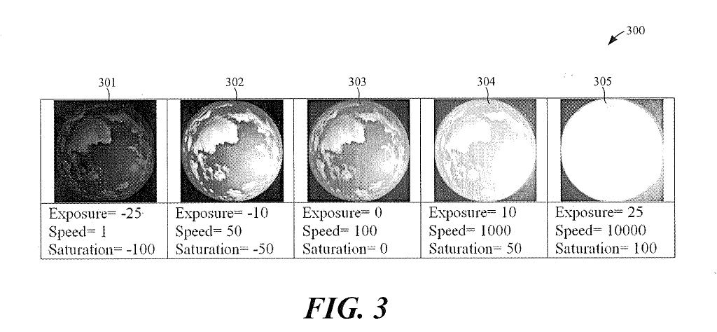

Thus, by varying aspects of exposure, sensitivity, shutter speed, saturation, aperture, etc., used by the imaging assembly 180, it is possible to control the exposure of images individually in an array of images. In that context, multi-exposure image capture allows the imaging device 160 to capture a relatively full range of data in multiple exposures even in natural solar illumination, and FIG. 3 illustrates an example array of images 300, including images 301-305 captured by the imaging device 160. The array of images 300 can be captured by the imaging assembly 180 at any suitable periodic interval and time spacing.

To maximize the information captured by imaging assembly 180, the image capture engine 182 is configured to adjust one or more parameters of image capture by the imaging assembly 180. As one parameter, the image capture engine 182 can adjust the exposure compensation of the image sensor in the imaging assembly 180 by adjusting the signal gain or sensitivity of the image sensor as shown among the images 301-305 in FIG. 3. In other words, signal gain values can range from −25 (darker) to 25 (lighter). As one example, each increment can represent an apparent ⅙th of a stop in that case.

The image capture engine 182 can also adjust the shutter or capture speed of the imaging assembly 180. For example, the shutter speed values can range from 1 (e.g., for a short exposure) to 6000000 (e.g., for a long exposure). The image capture engine 182 can also adjust the color saturation of the image sensor in the imaging assembly 180 as an integer between −100 and 100, for example, as also shown among the images 301-305 in FIG. 3. The adjustment of the color saturation can control whether colors are bright or washed out. Thus, the number of photons gathered by the image sensor in the imaging assembly 180 can be a function of various parameters including exposure, sensitivity, shutter speed, saturation, aperture, etc., and the image capture engine 182 can direct the imaging assembly 180 to vary those parameters when capturing images over time.

The exposure time (e.g., speed) of each of the images 301-305 varies, but an average of the exposure times for all the images 301-305 can be calculated by the image capture engine 182 and stored in the image data 172. For example, the image capture engine 182 can store a 5-image (or n-image) inverse exposure speed as a surrogate for apparent solar irradiance every ten seconds. Further, the image capture engine 182 can store the white balance (red, blue) tuple values in the image data 172 for each of the images 301-305 and an average of the white balance tuple values every ten seconds for further processing of consecutive combined-detail images. The red and blue values can be returned as real numbers between 0.0 and 8.0, for example.

Referring again to FIG. 2, at step 204, the process includes the image processor 184 combining the array of images captured at step 202 (and/other previously captured images) into a super-resolution, super-range, or combined-detail image (e.g., a superimage). In that way, the embodiments can account for the large spatial and dynamic range needed to accurately capture details in a field of view in the sky. In one embodiment, any two or more of the images 301-305 in the array of images 300 can be combined by the image processor 184 to create a combined-detail image in step 204. The combination of any two or more of the images can occur before, after, or as part of one or more image processing techniques among high dynamic range HDR imaging, HDR tone mapping, image fusion, or others. It should also be appreciated that any number of image arrays can be captured by imaging assembly 180 before generating combined-detail images and/or further processing them.

The image processor 184 can generate a multi-frame combined-detail image using two instance-in-time images at each exposure. This approach uses sub-pixel shifts between multiple low-resolution images of the same scene. This approach also represents a robust method of combined-detail image generation based on the use of the L1 vector norm both in the regularization and the measurement terms of the penalty function. The approach removes outliers efficiently, resulting in images with sharp edges even for images in which the noise follows a Gaussian model.

At step 204, the camera-specific response function can also be recovered in order to linearize the intensities and merge images to achieve HDR images with no or little saturation artifacts. This calibration step can be computed from the input sequence and their exposure settings. To correct for limitations of graphic display devices, the image data can be compressed to fit within the given display range using tone-mapping techniques. In one embodiment, tone mapping employs a bilateral filter for correction. This assumes perfect or near-perfect alignment of images, and the multi-exposure data sampling must be registered using the same L1 norm minimization as in combined-detail images. This is particularly important in regions of interest (ROI) around low-level cumulus clouds. Image fusion image processing includes combining relevant information from two or more images into a single, fused image. The fused image can have complementary spatial and spectral resolution characteristics.

The contrast of images can be used to individually weight the images when combining them. In certain embodiments, the image processor 184 is configured to combine arrays of images using one or more of the HDR, tone mapping, and image fusion processing techniques separately, and select the best resultant combination of the images. In other embodiments, the image processor 184 is configured to apply two or more of the HDR, tone mapping, and image fusion processing techniques when combining images. In one embodiment, the image processor 184 performs the HDR merging, tone mapping, image fusion, etc. and/or other processes on a periodic basis. For example, every ten seconds (or any other suitable periodic cycle), a new combined-detail image can be created at step 204, although combined-detail images can be created at any suitable time interval.

At step 206, the process includes the image processor 184 transforming the combined-detail image generated at step 204 into a transformed image. Here, the image processor 184 can perform a calibration transformation to account for distortion induced by one or more wide-angle optical components, such as wide-angle lenses, mirrors, etc., of the imaging assembly 180. For example, in the case of using a wide-angle lens (e.g., a fisheye lens), the image processor 184 can perform a process of lens calibration and/or transformation. While the use of a non-perspective wide-angle lens allows for the capture of a wider panorama with fewer images, it can also introduce radial distortion, wrap-around effects, and other distortion.

Since a wide-angle lens in the imaging assembly 180 projects rays of light from all directions onto the two-dimensional surface of an image sensor in the imaging assembly 180, a nodal point on the lens can be specified by two angles, θ and ϕ. In that scenario, an equidistance projection model sends rays of light to the image position (x,y) on the image sensor, x=c θ cos ϕ and y=c θ sin ϕ and c is a scale factor. For solar irradiance measurement and forecasting, the image processor 184 can use the two angles sθ and ϕ and to ascertain the cloud base height of moving clouds. To do this accurately, the detailed technical specifications of the wide-angle lens may be known and stored in the imager data store 170.

In one embodiment, without that information being freely available from the manufacturer, the image processor 184 can self-calibrate the distortion effects of any wide-angle optical components in the imaging assembly to determine and characterize its field of view. In that context, FIG. 4 illustrates an example calibration table setup 400 and geometric transformation matrix 410 for distortion self-calibration according to various embodiments described herein.

To self-calibrate, a first plane 401 and a second plane 402 parallel to each other and perpendicular to the optic axis can be used with the first plane 401 located in the immediate proximity of the camera lens (e.g., within 20 mm) and the second plant 402 located a few millimeters away with a chessboard pattern of white/black squares embossed on its surface. A micrometer can be used to measure the distance between the planes 401 and 402 to sub-millimeter accuracy. In this configuration, a first image can be acquired. Then, the second plane 402 can be moved 10 mm further away, for example, from the first plane 401, and a second image acquired, as illustrated in FIG. 4. The image processor 184 can then use the change in location of the corners of the squares in the two images to self-calibrate the wide-angle lens. The dot product of the vectors obtained using the first plane 401 and the second plane 402 can be used to produce the transformation vectors in the transformation matrix 410 shown in FIG. 4.

The image processor 184 can use the transformation matrix 410 to convert combined-detail images (or other images captured by the imaging assembly 180) into geometrically-representative (e.g., non-distorted) all-sky transformed images without making assumptions using manufacturer-produced geometries of wide-angle optical components. Once the transformation matrix 410 is obtained during the calibration phase, it can be considered a constant function and stored in the imager data store 170 for reference by the image processor 184.

Referring again to FIG. 2, at step 208, the process further includes the cloud tracker 186 identifying and tracking cloud features in the transformed images generated at step 206. For example, the transformed images can be segmented into areas of clouds and areas of sky using a method of red-to-blue ratio segmentation. More particularly, the cloud tracker 186 can calculate red to blue ratios for both a current transformed image and a corresponding clear sky matching image. The subtraction of those two images can help to isolate clouds in the transformed image. The majority of clear sky red/blue ratio intensities are likely to be at the lower end of the intensity scale, while the red/blue ratio intensities in the transformed image are likely spread out along the range of intensities. When the clear sky image is subtracted by the cloud tracker 186 from the transformed image, all that may remain in the resultant image is cloudy areas, with the clear sky areas having been zeroed out. The result from the subtraction of the clear sky red/blue ratio from the transformed image red/blue ratio is that the darkest areas of the image indicate areas with no clouds, and lighter areas indicate dense clouds. The final phase in the cloud identification or detection process is the selection of threshold limits that identify the cloudy regions or areas. The cloud tracker 186 can use a number of different thresholds to account for density variability in clouds. These thresholds can have distinct effects on the irradiance intensity through cloud layers.

To make solar forecasting predictions of solar irradiance, the cloud tracker 186 can also track or follow the future location of clouds. In intra-hour forecasting, for example, one method involves obtaining the general motion of all the clouds, calculating the cloud cover percentage, projecting all the clouds linearly into the future, and calculating the change in cloud cover percentage. Another method depends on finding the general direction and then analyzing a narrow band of sky in the direction of approaching clouds. That band is separated into regions, and the cloud coverage for each region is calculated. The regions are then projected into the future in the general direction to determine a future cloud coverage value.

According to aspects of the embodiments, motion as well as shape characteristics of individual clouds can be followed by the cloud tracker 186 to make future predictions of cloud locations. Particularly, at step 208 in FIG. 2, the process includes determining the motion of one or more clouds in transformed images. Prior methods of analyzing cloud motion consisted of treating an entire cloud base as one object and displacing the entire object linearly to make predictions. In the embodiments described herein, clouds are treated as individual specimens that can have different trajectories and changes in shape and/or size. Thus, the embodiments described herein capture more of the dynamics involved in cloud formation and dissipation. The process consists of three main steps, including acquiring the general motion of individual clouds, acquiring the individual motion vector of the individual clouds, and creating future or predicted sky images one or more given times in the future.

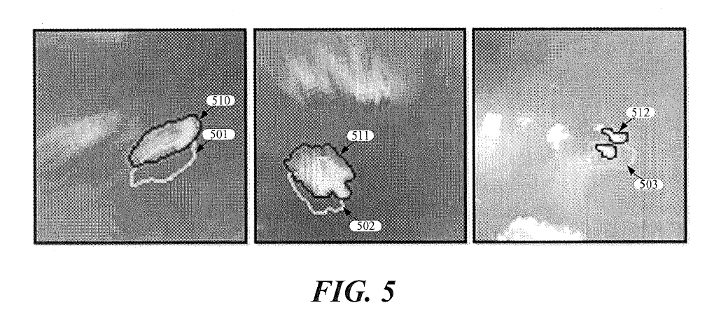

FIG. 5 illustrates an example result of a cloud matching and tracking process according to various embodiments described herein. In FIG. 5, the regions 501-503 are representative of previous clouds and the regions 510-512 are representative of current clouds. The leftmost and middle images show the detection of single cloud matches and the image on the right shows an example of a current cloud with two matching results. During the matching process, the direction, speed, height, and change in area of each individual cloud can be recorded by the cloud tracker 186 and stored in the imager data store 170. In the case of two clouds being matched, the direction, speed and change in area can be calculated to the weighted centroid of the detected regions. The last step in the process is to create the future or predicted sky images from which forecast predictions can be made. In that context, the cloud tracker 186 can create future or predicted sky images based on the direction, speed, and change in area information for individual clouds over time. For example, each cloud can be individually cropped out of an image and placed in a new location in the predicted sky image based on the direction and distance traveled and resized according to the change in area.

Referring again to FIG. 2, at step 210, the process further includes the forecast engine 188 generating a solar forecast based on current and/or future cloud features present in current transformed and/or future predicted images, as identified and tracked by the cloud tracker 186 at step 208. As part of the generation of the solar forecast, the forecast engine 188 can perform solar ray tracing. Particularly, at step 210, the process can include the forecast engine 188 generating a solar energy forecast by ray tracing the irradiance of the sun upon geographic locations based on the motion of one or more clouds. In the step of ray tracing, current (transformed or non-transformed) and future sky images can be relied upon to determine where rays from the sun will and will not fall upon various ground locations over time and generate a ground solar irradiance map. Images of one or more ground locations, with either a point of interest designated (e.g., location of irradiance sensor) or a region of points selected (e.g., solar array) can be used as an input.

After ray tracing, the forecast engine 188 can establish a solar forecast using ground solar irradiance maps and based on the motion vectors from the feature-based advection model and ray-tracing processes. Because future cloud features and images are used, the solar forecast can include solar irradiance maps, for example, 5-, 10- and 15-minutes (or others) ahead. The forecast engine 188 can thus create a geographically relevant ground-based matrix with irradiance values in future times.

At step 212, the process includes the forecast engine 188 transmitting current and future sky images, solar forecast data, ground solar irradiance maps, and other relevant data to the computing environment 110 for further processing. In one embodiment, compressive sensing can be used to find sparse representations, periodically, from dynamically changing dictionaries of combined-detail images in which cloud features are being detected. For example, three images I(t1), I(t2), and I(t3), for example, acquired close together in time may show relatively little change, so that the difference I(t1)−I(t3) is sparse in the standard basis, and compressive sensing can be used to transmit these differences among the networked environment 100. This data will then be combined with many other types and sources of data in the computing environment 110 to address the longer range, day-ahead forecasting problem and produce massive data sets of spatially representative irradiance maps.

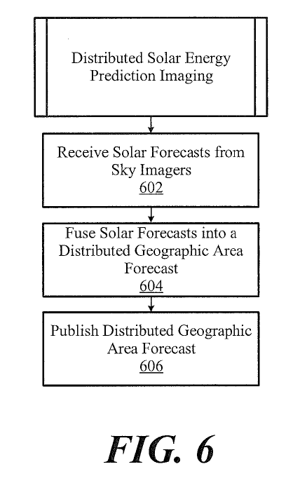

FIG. 6 illustrates an example process for distributed solar energy prediction imaging performed by the computing environment 110 in FIG. 1. At step 602, the process includes the computing environment 110 receiving current and future sky images, solar forecast data, ground solar irradiance maps, and other relevant data from the imaging devices 160-162, among others.

In turn, at step 604, the process includes the distributed area forecast engine 130 combining or fusing the respective solar forecast data received from each of the imaging devices 160-162 into a distributed geographic area solar forecast. Additionally or alternatively, the distributed area forecast engine 130 can fuse together sky images (e.g., current, past, and/or future sky images) received from the imaging devices 160-162 to generate a distributed geographic area solar forecast as described herein. The fused and/or combined data can be stored in the distributed data store 120.

At step 606, the process includes the distributed forecast publisher 132 publishing or making available the distributed geographic area solar forecast generated by the distributed area forecast engine 130 at step 604. The solar forecast data can be published to or provided for access by the client device 190, for example, in any suitable way.

Thus, during daylight hours, imaging devices 160-163 can capture multiple images at different exposures, process and analyze the images in real time, and predict cloud motion vectors that will produce solar irradiance data at current and future times as described herein. Since most of the processing can be done locally on the imaging devices 160-163 in a distributed manner, the amount of information that needs to be transmitted to the computing environment 110 can be reduced. The use of fusion post-processing at the computing environment 110 provides the benefit of additional accuracy in distributed solar forecasting, because cloud horizontal projection decreases with distance away from the imager. The farther away the clouds are located, if the cloud layer is discontinuous, it creates vertical cloud depths that do not accurately represent cloud motion and cloud base height. The fusion of data at the computing environment 110 can create a single reliable map for larger geographies than the area encompassed by any single one of the imaging devices 160-163.

Using the embodiments described herein, an accurate measurement of the number of photons passing through the atmosphere as a function of time can be determined. Photons traveling from the sun and being scattered in route produce direct and diffuse irradiance, and in the process, produce diurnal heating of the atmosphere. In this way, accurate irradiance estimates and forecasts are critical to the power industry, not just for predicting photovoltaic plant output, but to give precise temperature, hence electricity demand forecasts.

Solar-generated power systems can be made grid-friendly through participation in grid ancillary services such as frequency regulation and dynamic volt/var control. These grid friendly systems can be made as dispatchable as traditional power plants, provided that accurate solar forecasting is available at different time scales. In a largescale solar power plant with several inverters or in a distributed network of residential buildings with solar generation, it is possible to have a coordinated control of the inverters to effectively use the reserve capacity when participating in frequency regulation. Having an accurate intra-hour solar forecast can enable implementation of a coordinated inverter control strategy capable of regulating set-point power. The proposed low-cost sky-imaging and forecasting methods and systems described herein enable dispatchability functionality for solar-generated power plants, whether they are for utility-scale power plants or smaller distributed power generating facilities.

The flowcharts in FIGS. 2 and 6 show examples of the functionality and operation of various components described herein. The components described herein can be embodied in hardware, software, or a combination of hardware and software. If embodied in software, each element can represent a module of code or a portion of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts show a specific order of execution, it is understood that the order of execution can differ from that which is shown. For example, the order of execution of two or more elements can be switched relative to the order shown. Also, two or more elements shown in succession can be executed concurrently or with partial concurrence. Further, in some examples, one or more of the elements shown in the flowcharts can be skipped or omitted.

The computing devices described herein can include at least one processing circuit. The processing circuit can include, for example, one or more processors and one or more storage devices that are coupled to a local interface. The local interface can include, for example, a data bus with an accompanying address/control bus or any other suitable bus structure. The one or more storage devices can store data or components that are executable by the one or more processors of the processing circuit.

The components of the computing environment 110 and the imaging devices 160-162 can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that include software or program instructions can be embodied in a non-transitory computer-readable medium for use by or in connection with an instruction execution system such as one of the processors or processing circuits described herein. The computer-readable medium can contain, store, and/or maintain the software or program instructions for use by or in connection with the instruction execution system. A computer-readable medium can include a physical media, such as, magnetic, optical, semiconductor, and/or other suitable media. Examples of suitable computer-readable media include, but are not limited to, solid-state drives, magnetic drives, or flash memory.

Further, any component described herein, including the distributed area forecast engine 130, distributed forecast publisher 132, imaging assembly 180, image capture engine 182, image processor 184, cloud tracker 186, and forecast engine 188, can be implemented and structured in a variety of ways. For example, one or more components can be implemented as modules or components of a single software application module. Further, one or more components described herein can be executed in shared or separate computing devices or a combination thereof. For example, a plurality of the components described herein can execute in the same computing device, or in multiple computing devices. Additionally, terms such as “application,” “service,” “system,” “engine,” “module,” and so on can be used interchangeably and are not intended to be limiting.

Disjunctive language, such as the phrase “at least one of X, Y, or Z,” unless specifically stated otherwise, is to be understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A solar forecast system, comprising:
a computing environment;
a network; and
an imaging device communicatively coupled to the computing environment via the network, the imaging device comprising an imaging assembly and a computing device, the computing device being configured to:
capture an array of images using the imaging assembly;
combine the array of images into a combined-detail image;
identify and track cloud features in the combined-detail image;
generate a solar forecast using ray tracing based on the cloud features in the combined-detail image; and
transmit the solar forecast to the computing environment via the network.

2. The solar forecast system according to claim 1, wherein the computing device of the imaging device is further configured to tone map the array of images to combine the array of images into the combined-detail image.

3. The solar forecast system according to claim 1, wherein:
the imaging assembly comprises a wide-angle optical component to capture a wide view of sky in the array of images; and
the computing device of the imaging device is further configured to transform the combined-detail image into a transformed image based on a calibration transformation matrix associated with the wide-angle optical component.

4. The solar forecast system according to claim 1, wherein:
the imaging device comprises a plurality of imaging devices; and
each of the plurality of imaging devices transmits a respective solar forecast to the computing environment via the network.

5. The solar forecast system according to claim 4, wherein the plurality of imaging devices comprise a distributed geographical network of solar forecast imaging devices.

6. The solar forecast system according to claim 4, wherein the computing environment is configured to combine the respective solar forecast from each of the plurality of imaging devices into a distributed geographic area solar forecast.

7. The solar forecast system according to claim 4, wherein the computing environment is configured to combine cloud height and horizontal projection data among the respective solar forecast from each of the plurality of imaging devices.

8. A solar forecast method, comprising:
capturing, by a computing device, an array of images using an imaging assembly;
combining, by the computing device, the array of images into a combined-detail image;
transforming, by the computing device, the combined-detail image into a transformed image; and
tracking, by the computing device, cloud features in the transformed image.

9. The solar forecast method according to claim 8, wherein combining the array of images further comprises tone mapping the array of images.

10. The solar forecast method according to claim 8, wherein:
the imaging assembly comprises a wide-angle optical component to capture a wide view of sky in the array of images; and
transforming the combined-detail image comprises transforming, by the computing device, the combined-detail image into the transformed image based on a calibration transformation matrix associated with the wide-angle optical component.

11. The solar forecast method according to claim 8, further comprising generating, by the computing device, a solar forecast using the transformed image and based on the cloud features.

12. The solar forecast method according to claim 11, wherein:
the transformed image comprises one of a plurality of transformed images captured over a distributed geographic area; and
the method further comprises fusing, by the computing device, the plurality of transformed images to generate a distributed geographic area solar forecast.

13. The solar forecast method according to claim 12, wherein the fusing comprises combining, by the computing device, cloud height and horizontal projection data from the plurality of transformed images.

14. An imaging device, comprising:
a computing device; and
an imaging assembly comprising a wide-angle optical component, the computing device being configured to:
capture an array of images using the imaging assembly;
combine the array of images into a combined-detail image; and
transform the combined-detail image into a transformed image based on a calibration transformation matrix associated with the wide-angle optical component.

15. The imaging device according to claim 14, wherein the computing device is further configured to tone map the array of images to combine the array of images into the combined-detail image.

16. The imaging device according to claim 14, wherein the computing device is further configured to identify and track cloud features in the transformed image.

17. The imaging device according to claim 16, wherein the computing device is further configured to generate a solar forecast using ray tracing based on the cloud features in the transformed image.

18. The imaging device according to claim 17, wherein the computing device is further configured to transmit the solar forecast to a computing environment via a network.

19. The imaging device according to claim 18, wherein the computing environment receives a plurality of solar forecasts from a plurality of imaging devices in a distributed geographical network of imaging devices.

20. The imaging device according to claim 19, wherein the computing environment is configured to combine the plurality of solar forecasts into a distributed geographic area solar forecast.
